(19) United States
(12) Patent Application Publication
(10) Pub. No.: US 2011/0022489 A1
(43) Pub. Date: Jan. 27, 2011

(54) Third-Party Inspection of Vehicles in an Electronic Marketplace System

(76) Inventors: Zachary E. Hallowell, Portland, ME (US); Andrew IORGULESCU, San Francisco, CA (US)

Correspondence Address: Gregory & Martensen LLP, 2018 Bissonnet Street, Houston, TX, 77005, US

(21) Appl. No.: 12/796,436

(22) Filed: Jun. 8, 2010

Related U.S. Application Data
(63) Continuation-in-part of application No. 12/714,960, filed on Mar. 1, 2010.
(60) Provisional application No. 61/185,183, filed on Jun. 8, 2009.
(60) Provisional application No. 61/185,932, filed on Jun. 10, 2009.

(51) Int. Cl. G06Q 30/00

(52) U.S. Cl. 705/26.3; 705/26.61

(57) ABSTRACT

A Third-Party Inspection (TPI) System in which wholesale sellers of items, like automobiles for example, can order third party inspections of their vehicles online, automatically track the status of the inspections and have the inspections loaded to an online wholesale marketplace for sale. The TPI system allows dealers to manage the entire process, from inspection ordering to wholesale sale, through a single interface, by integrating inspection ordering, status tracking and receipt into an online system and an online wholesale marketplace.

### RELATED APPLICATIONS

This application claims the benefit of U.S. Patent Application No. 61/185,183, filed Jun. 8, 2009.

This application claims the benefit of U.S. Patent Application No. 61/185,932, filed Jun. 10, 2009.

This application is a continuation in part to U.S. patent application Ser. No. 12/714,960, filed Mar. 1, 2010.

This application is related to U.S. patent application Ser. No. 11/457,068, filed Jul. 12, 2006.

This application is related to U.S. patent application Ser. No. 11/457,074, filed Jul. 12, 2006.

This application is related to U.S. patent application Ser. No. 11/457,077, filed Jul. 12, 2006.

This application is related to U.S. patent application Ser. No. 11/681,727, filed Mar. 2, 2007.

This application is related to U.S. patent application Ser. No. 11/681,729, filed Mar. 2, 2007.

This application is related to U.S. patent application Ser. No. 11/685,120, filed Mar. 12, 2007.

This application is related to U.S. patent application Ser. No. 11/685,121, filed Mar. 12, 2007.

### TECHNICAL FIELD

This invention relates to processing systems and, more particularly, to an electronic marketplace system for transactions involving motor vehicles.

### BACKGROUND

Traditionally when parties involved in a wholesale automobile transaction, such as a dealership, leasing or rental company, describe a vehicle for sale online they will do it in one of two ways. A first way of describing such vehicles is to describe the vehicle and take pictures themselves (or using their personnel), using a set of online tools to describe the vehicle features and condition. Another method of describing the vehicles is to contact a third party inspection(TPI) company directly to have inspections performed for vehicles and electronically transmitted to the wholesale (or retail) venues of their choosing, such as OPENLANE.com, OVE.com or SmartAuction. This process is inefficient, since the seller must access multiple systems and establish relationships with third party inspection companies independently. Sellers often lack good access to the available options for performing inspections and lack any ability to negotiate price based on low volumes.

Also, in the case where a user describes the vehicle themselves, it is difficult to generate a sense of trust for buyers, since a seller may be unknown to the buyer and may choose not to disclose key items of damage or other issues with the vehicle in an attempt to get a potential buyer to pay more for the car. With the likelihood of a recurring relationship with the unknown seller, the buyer may choose not to purchase these vehicles.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a block diagram of the TPI management system, under an embodiment.

FIG. 2 is a block diagram of the TPI management system, under an embodiment.

FIG. 3 is a flow diagram for managing third party inspections of items in a wholesale marketplace, under an embodiment.

FIG. 4 is a block diagram of the Wholesale Virtual Inventory and Retail Lead Generation System (WVIRLGS), under an embodiment.

FIG. 5 is a block diagram of an online auction system, under an embodiment.

FIG. 6 is a more detailed block diagram of an online auction system, under an embodiment.

### DETAILED DESCRIPTION

A system is described in which wholesale sellers of items, like automobiles for example, may order third party inspections of their vehicles online, track the status of the inspections and have the inspections loaded to an online wholesale marketplace for sale. As opposed to all known processes for ordering third party inspections, this process is unique in that it allows dealers to manage the entire process, from inspection ordering to wholesale sale, through a single interface.

The system described herein provides an alternative approach, involving the integration of the inspection ordering, status tracking and receipt into an online system integrated within an online wholesale marketplace to allow for a drastically simplified online wholesaling process. The system of an embodiment enables a seller to access one system to order an inspection and offer for sale online. The listing process for a seller under the system of an embodiment is greatly simplified, making it easier for sellers to take advantage of a TPI to address the core “trust” issue between buyers and sellers. Furthermore, performance of the inspection company (i.e. their ability to represent vehicles accurately) can be tracked and this information pushed back to buyers. The system of an embodiment provides an increased sense of trust between buyer and seller. Furthermore, a buyer using the system of an embodiment realizes better expectations for the vehicle condition when buying online along with greater protections in the event of an arbitration.

In the following description, numerous specific details are introduced to provide a thorough understanding of, and enabling description for, embodiments of the present invention. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

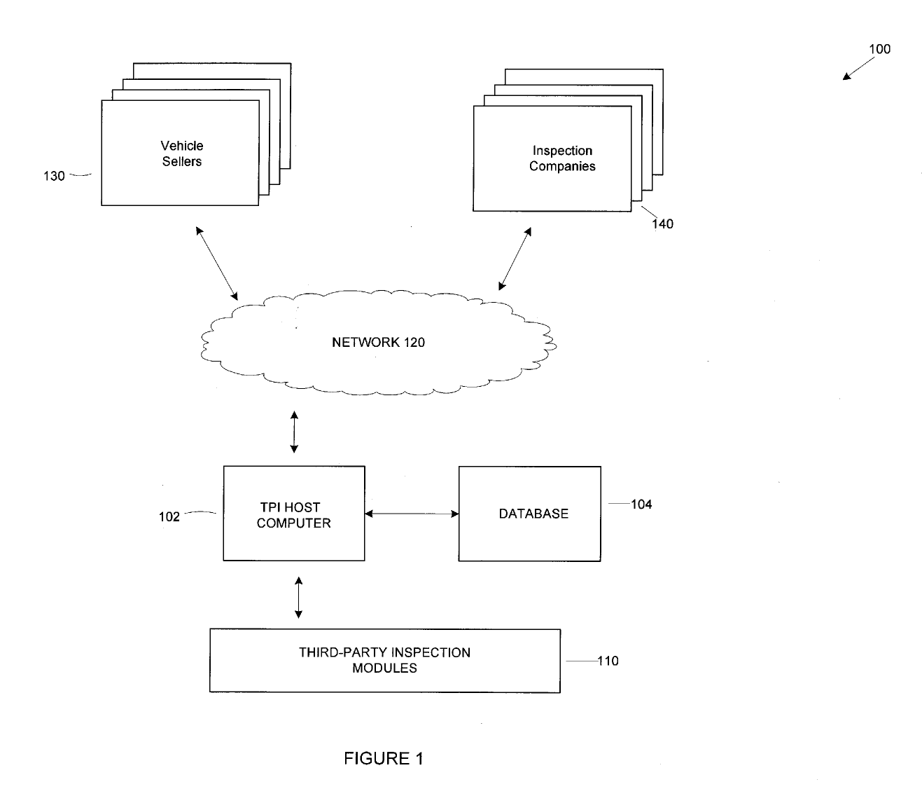

The system of an embodiment is referred to herein as the Online Third-Party Inspection Management System, or Third-Party Inspection Management System. FIG. 1 is a block diagram of the TPI management system 100, under an embodiment. The TPI management system comprises a host computer 102 coupled to a network 120, a database 104 coupled to the host computer 102, and a set of third-party inspection (TPI) modules 110 coupled to the host computer 102. The host computer 102 serves the vehicle data for specific vehicles with electronic data integration to third party inspection providers for requesting/receiving inspections and status updates. The host database 104 includes detailed description of the vehicles, along with configuration and condition information. The TPI modules 110 provide for the display, configuration, deployment and management of the third party inspection requests/receipt. Vehicle sellers 130 and inspection companies 140 access the host computer via the network 120.

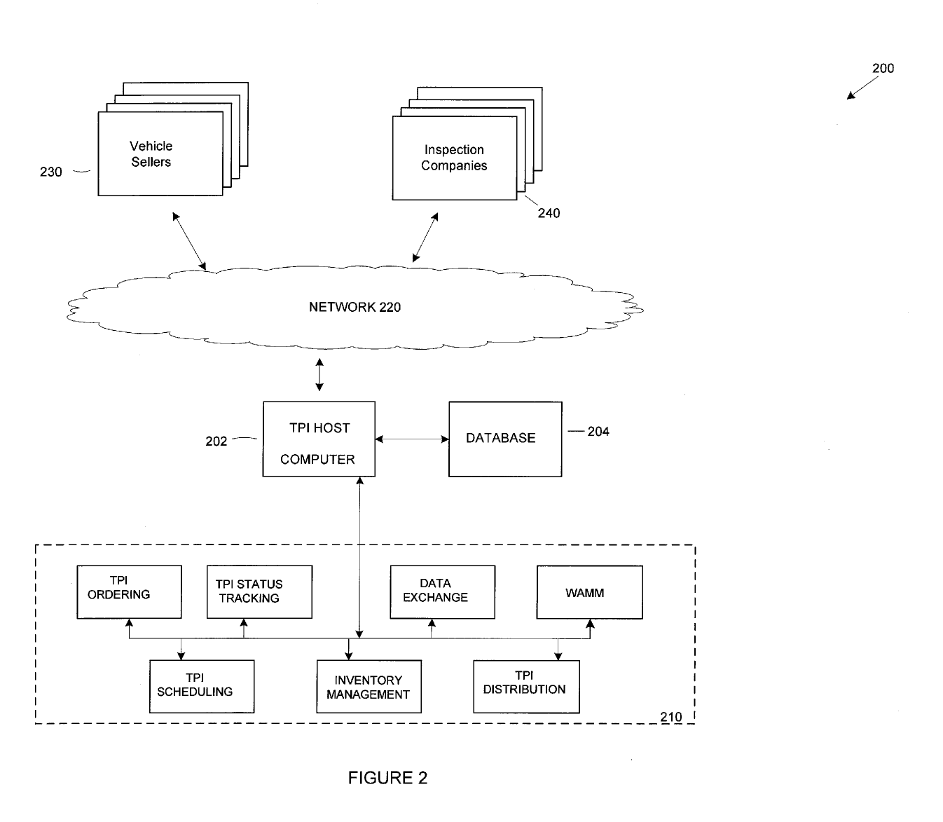

FIG. 2 is a block diagram of the TPI management system 200, under an embodiment. The TPI management system comprises a host computer 202 coupled to a network 220, a database 204 coupled to the host computer 202, and a set of third-party inspection (TPI) modules 210 coupled to the host computer 202. The host computer 202 serves the vehicle data for specific vehicles with electronic data integration to third party inspection providers for requesting/receiving inspections and status updates. The host database 204 includes detailed description of the vehicles, along with configuration and condition information. The TPI modules 210 provide for the display, configuration, deployment and management of the third party inspection requests/receipt. Vehicle sellers 230 and inspection companies 240 access the host computer via the network 220.

The TPI modules or components 210 of an embodiment comprise TPI administration, TPI scheduling, TPI ordering, TPI status tracking, data exchange, wholesale automobile market module (WAMM), wholesale inventory management, and TPI distribution modules, to name a few. Each of the TPI modules 210 is described in detail below.

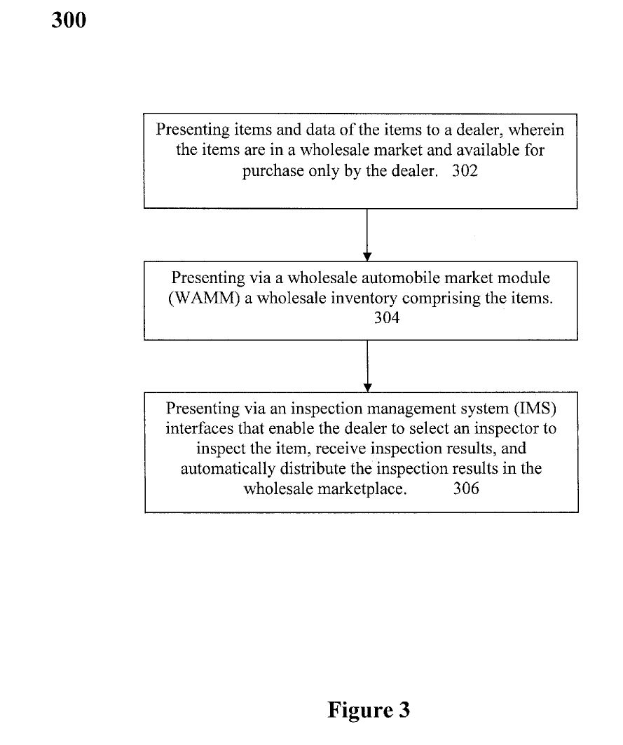

FIG. 3 is a flow diagram for managing third party inspections of items in a wholesale marketplace 300, under an embodiment. The inspection management comprises presenting to a dealer via an electronic platform items and data of the items 302. The items are in a wholesale market and are available for purchase only by the dealer in the wholesale market. The inspection management comprises presenting via a wholesale automobile market module (WAMM) coupled to the platform a wholesale inventory comprising the items 304. The inspection management comprises presenting via an inspection management system (IMS) coupled to the platform interfaces that enable the dealer to select from an inspector to inspect the at least one item, receive inspection results, and automatically distribute via the platform the inspection results in the wholesale marketplace 306.

With reference to FIG. 2, the admin module is primarily for the use of the provider of the online wholesale marketplace and comprises one or more interfaces. The admin module of an embodiment comprises an interface for managing the set-up of various third party inspection companies, including: Company Name, Address and contact information, Inspection types, Service Level Agreements and Terms of Use, and Company logo to name a few. The admin module of an embodiment comprises an interface for capturing detailed information about the seller who may be ordering third party inspections for their vehicles, such as name, address, phone number and contacts. The admin module of an embodiment comprises an interface for establishing whether a seller has access to the TPI Ordering component. The admin module of an embodiment comprises an interface (optional) for storing information related to the pricing structure of the third party inspections, including geographic coverage. The admin module of an embodiment comprises an interface (optional) for managing a username and password for the seller to access the TPI Management Module. The admin module of an embodiment comprises an interface (optional) for establishing the communication preferences for notifications (e-mail, text) related to the third party inspections. The admin module of an embodiment comprises an interface for managing how the seller of the vehicles for which third party inspections are ordered will be billed (such as monthly invoice, credit card, PayPal etc).

The TPI scheduling module of an embodiment is generated by the provider and takes the form of a module within the provider's online wholesale marketplace. The primary user is the seller of the vehicle, and the functionality of this component allows the seller to set-up a regular visit by a third party inspection company. The TPI scheduling module of an embodiment comprises an interface for choosing which inspection company they would like to perform the inspection. The TPI scheduling module of an embodiment comprises an interface for indicating the preferred day and time of the inspection.

The TPI ordering module of an embodiment is generated by the provider and takes the form of a module within the provider's online wholesale marketplace. The primary user is the seller of the vehicle. The TPI ordering module of an embodiment includes an interface for searching the set of vehicles belonging to the seller (which may have been loaded to the system manually, or via data integration).

The TPI ordering module of an embodiment includes an interface for indicating for which vehicles a third party inspection should be ordered. The inspection of an embodiment is ordered by entering the VIN number (or a similar unique identifier for the vehicle) if the vehicle were not already in the system. The inspection of an embodiment is ordered by selecting vehicles from among the vehicles already loaded to the seller's inventory.

The TPI ordering module of an embodiment includes an interface for choosing a third party to perform the inspections and a type of inspection to be performed. Historical performance of an inspection company may be displayed, such as historical performance (average time from inspection request to receipt of inspection from the TPI company), and quality (percentage or number of vehicles inspected involved in a misrepresentation or other transaction issues).

The TPI ordering module of an embodiment includes an interface for deciding how to pay for the inspections (e.g., Invoice, Credit Card, ACH payment, wire payment, PayPal, etc.). The TPI ordering module of an embodiment includes an interface for choosing the location of the vehicle(s). The TPI ordering module of an embodiment includes an interface for confirming the order details and final submission. The TPI ordering module of an embodiment includes an interface to accept the terms of use and service level agreement for the chosen inspection company and type.

Upon final submission an electronic inspection order is sent to the selected inspection company. This order can take the form of a Web Service, XML or a “batch” XML or delimited file transfer or other electronic means of communication.

The TPI inspection status tracking module is generated by the provider for the seller. The TPI inspection status tracking module of an embodiment comprises an interface for searching the set of vehicles in the dealer's inventory for which a Third Party Inspection has been ordered. The TPI inspection status tracking module of an embodiment comprises an interface for viewing the search results produced by the search interface. The TPI inspection status tracking module of an embodiment comprises an interface for viewing the details of a specific vehicle (i.e. a detail page), such as the Year, Make, Model, Trim, Mileage, VWIN (full or partial) Colors, engine, drivetrain, transmission, damage information, consignor comments and pictures, to name a few. The TPI inspection status tracking module of an embodiment comprises an interface for viewing the status of the vehicle inspection, such as Inspection Requested, Inspection Scheduled, and Inspection complete to name a few. The TPI inspection status tracking module of an embodiment comprises an interface for viewing notes from the inspection company, related to the status of each inspection order.

The TPI inspection status tracking module of an embodiment comprises an interface for canceling the third party inspection. The cancellation can take the form of a Web Service, or a “batch” XML or delimited file transfer or other electronic means of communication.

The TPI inspection status tracking module of an embodiment comprises an interface for a user to manage notifications related to the inspection status. The notifications can be sent via e-mail or other electronic means of communication, and the notifications include information of Order of inspections, Cancellation of inspections, and Receipt of completed inspection to name a few.

The data exchange module is hosted by the provider and the inspection company, primarily for use by the provider and Third Party Inspection Company. The data exchange module of an embodiment comprises one or more of a data exchange interface for communicating inspection orders, a data exchange interface for communicating inspection cancellations, a data exchange interface for communicating inspection status, a data exchange interface for communicating completed inspections, and a data exchange interface for communicating billing information.

The WAMM is targeted at allowing organizations licensed to buy or sell wholesale automotive inventory. The WAMM can be administered by the provider or a partner. The WAMM of an embodiment comprises one or more of an interface to register for access to the system, an interface for searching for a set of wholesale automobile inventory, an interface for viewing the search results produced by the search interface, an interface for bidding on or buying the available vehicle, and an interface for viewing the details of a specific vehicle (i.e. a detail page), such as the Year, Make, Model, Trim, Mileage, VWIN (full or partial) Colors, engine, drivetrain, transmission, damage information, consignor comments and pictures.

The inventory management module is targeted at allowing organizations licensed sell wholesale automotive inventory to manage their inventory online. The inventory management module can be administered by the provider or a partner. The inventory management module of an embodiment comprises one or more of an interface for searching for the seller's available inventory, an interface for viewing the search results for a query of the seller's inventory, and an interface for managing each listing (vehicle configuration, price, condition information, title information).

The TPI distribution module can hosted by the provider and allows the seller of the vehicle to select to have the inspection distributed to other wholesale (or retail sites). The TPI distribution module allows the seller the ability to limit the information distributed to each of the chosen sites. The TPI distribution module comprises an interface for paying for the inspection to be distributed to other sites.

Under a first example of the TPI management system involving a TPI order, using the Admin Component, the provider configures three inspection companies within the system with pricing models for several inspection types. The provider configures a seller of wholesale vehicles, including a user associated with the seller who is able to order third party inspections. The seller logs into provider's Wholesale Automotive Market Module and enters the TPI Ordering module. The seller views the three inspection companies available to perform inspections in their area, where inspection performance is displayed for each TPI company, and several inspection types are available for each TPI Company. The seller chooses Inspection company A to perform the inspection. The seller enters VINs for 10 vehicles. The seller chooses indicates vehicles are located at a specific street, city, state, zip code and the contact information at that location. The seller chooses to pay for the inspections via an ACH debit from their checking account and enters the associated information. The seller confirms order and receives an e-mail notification indicating the 10 VINS for which an inspection has been ordered. A real-time web-service inspection request is sent to the chosen inspection company. The inspection company schedules the inspections and generates a status update to the provider using the data exchange module. The seller receives an e-mail notification of the scheduled inspection date and views the status details in the providers system. The inspection company performs the inspection on the vehicle and sends the completed inspection electronically to the WAMM provider. The WAMM provider loads the completed inspection and sends a notification to the seller who ordered the vehicle. The seller logs into the system and locates the vehicle for which the completed inspections have been performed. The seller sets wholesale prices and releases the vehicle for sale on the provider's on-line auction.

Under a second example of the TPI management system involving a scheduled TPI, using the Admin Component, the provider configures three inspection companies within the system with pricing models for several inspection types. The provider configures a seller of wholesale vehicles, including a user associated with the seller who is able to order third party inspections. The seller logs into provider's Wholesale Automotive Market Module and enters the TPI Scheduling module. The seller views the three inspection companies available to perform inspections in their area, where inspection performance is displayed for each TPI company, and several inspection types are available for each TPI Company. The seller chooses Inspection company A to perform their inspections. The seller chooses to have the inspection company visit the dealership every week, on Monday, at 10:00 AM and indicates the exact location to be visited. The seller chooses to pay for the inspections via a Credit Card payment and enters the associated information. A real-time web-service inspection schedule order is sent to the chosen inspection company. The inspection company contacts the dealer to confirm the time. The inspection company performs inspections at the seller's location on the vehicle and sends the completed inspection(s) electronically to the WAMM provider. The WAMM provider loads the completed inspection(s) and sends a notification to the seller who ordered the vehicle. The seller logs into the system and locates the vehicle for which the completed inspections have been performed. The seller sets wholesale prices and releases the vehicle for sale on the provider's on-line auction.

Under a third example of the TPI management system involving a canceled TPI, using the Admin Component, the provider configures three inspection companies within the system with pricing models for several inspection types. The provider configures a seller of wholesale vehicles, including a user associated with the seller who is able to order third party inspections. The seller logs into the Wholesale Automotive Market Module and enters the TPI Ordering module. The seller views the three inspection companies available to perform inspections in their area, where inspection performance is displayed for each TPI company, and several inspection types are available for each TPI Company. The seller chooses Inspection company A to perform the inspection. The seller enters VINs for 10 vehicles. The seller chooses indicates vehicles are located at a specific street, city, state, zip code and the contact information at that location. The seller chooses to pay for the inspections via an ACH debit from their checking account and enters the associated information. The seller confirms order and receives an e-mail notification indicating the 10 VINS for which an inspection has been ordered. A real-time web-service inspection request is sent to the chosen inspection company. The seller logs into the providers status tracking module and cancels the inspection. A real-time web-service cancellation is sent to the inspection company. The seller receives an e-mail confirming the cancellation of the inspection.

Under a fourth example of the TPI management system involving a TPI ordered and distributed, using the Admin Component, the provider configures three inspection companies within the system with pricing models for several inspection types. The provider configures a seller of wholesale vehicles, including a user associated with the seller who is able to order third party inspections. The seller logs into the Wholesale Automotive Market Module and enters the TPI Ordering module. The seller views the three inspection companies available to perform inspections in their area, where inspection performance is displayed for each TPI company, and several inspection types are available for each TPI Company. The seller chooses Inspection company A to perform the inspection. The seller enters VINs for 10 vehicles. The seller chooses indicates vehicles are located at a specific street, city, state, zip code and the contact information at that location. The seller chooses to pay for the inspections via an ACH debit from their checking account and enters the associated information. The seller confirms order and receives an e-mail notification indicating the 10 VINS for which an inspection has been ordered. A real-time web-service inspection request is sent to the chosen inspection company. The inspection company schedules the inspections and generates a status update to the provider using the data exchange module. The seller receives an e-mail notification of the scheduled inspection date and views the status details in the providers system. The inspection company performs the inspection on the vehicle and sends the completed inspection electronically to the WAMM provider. The WAMM provider loads the completed inspection and sends a notification to the seller who ordered the vehicle. The seller logs into the system and locates the vehicle for which the completed inspections have been performed. The seller accesses the TPI Distribution Module and elects to have the inspection sent to a retail site, choosing to display the pictures, be not to send damage which the seller will repair. The seller enters credit card information to pay for the distribution and submits the request. The provider generates a real-time inspection request to the inspection provider directing the provider to distribute the inspection to the retail site.

The TPI system of an embodiment provides a platform that allows wholesale sellers to manage the entire wholesale sales process, from inspection ordering to wholesale sale, through a single interface, as described above. The platform integrates the inspection ordering, status tracking and receipt into an online system integrated within an online wholesale marketplace to allow for a drastically simplified online wholesaling process. The TPI system thus enables a seller to access one system to order an inspection and offer an item for sale online.

The TPI modules or components of an embodiment comprise a wholesale automobile market module (WAMM), as described above, which allows organizations to buy or sell wholesale automotive inventory. The TPI also includes an inventory management module that allows organizations licensed to sell wholesale automotive inventory to manage their inventory online. The WAMM and/or the inventory management module can be shared with and/or coupled to a Wholesale Virtual Inventory and Retail Lead Generation System (WVIRLGS). The WVIRLGS includes systems and methods for presenting vehicles available for wholesale purchase to retail consumers in order to generate a retail “lead” on a specific vehicle. The lead, once generated, is made available to a licensed dealer before the dealer has acquired the inventory that generated the lead. As opposed to all known lead generation models, the lead is created on a specific vehicle that a retail dealer has the ability to purchase, but has not yet purchased and does not have in the dealer inventory.

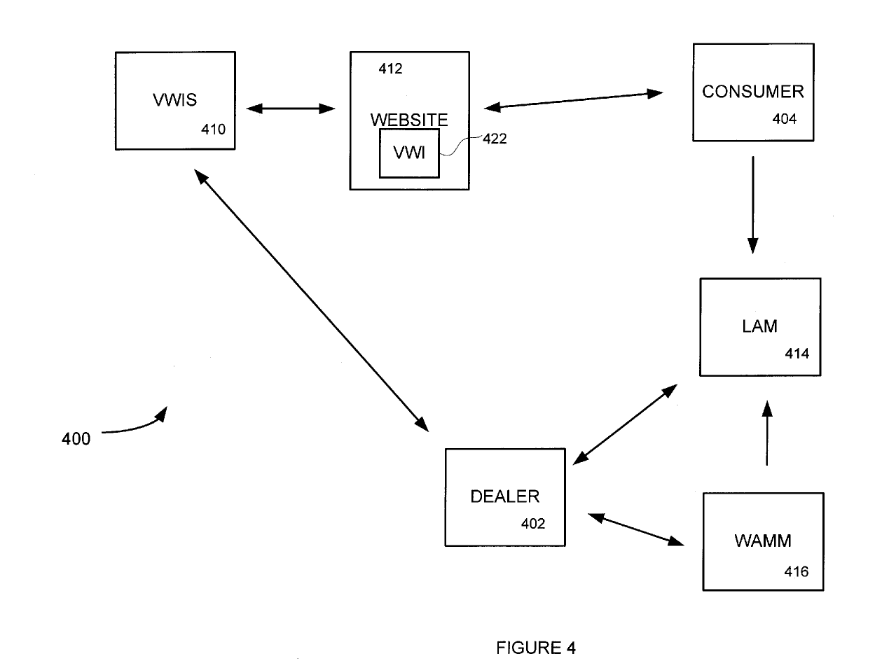

FIG. 4 is a block diagram of the Wholesale Virtual Inventory and Retail Lead Generation System (WVIRLGS) 400, under an embodiment. The WVIRLGS 400 allows the dealer to capture interest from a specific, named retail consumer 404 on a specific vehicle available for purchase (by dealers 402 only) in a wholesale market prior to acquiring the inventory.

The WVIRLGS 400 comprises a virtual wholesale inventory service (VWIS) platform 410. The VWIS platform 410 includes at least one server or host computer network coupled to a database (not shown), wherein the server(s) executes or includes presentation logic, filters, and user modules as described in detail below. The VWIS platform 410 can include or be coupled to the TPI management system described above and, as such, integrate the inspection management into the WVIRLGS 400. The host computer network serves the wholesale vehicle data for specific vehicles to a retail automotive “classified” web-site (or several web-sites) for the purpose of eventually selling a vehicle to a retail consumer. The host database includes a detailed description of each vehicle in the database, including the vehicle configuration and condition. The set of user modules provide for the display, configuration, deployment and management of the lead generation modules.

The VWIS platform 410 includes an administrative module (not shown) coupled to the server(s), as described in detail below. The administrative component of an embodiment is generally used by the provider of the VWIS, but is not so limited. The administrative component comprises one or more of an interface for enabling the exposure of the wholesale vehicle inventory, an interface for capturing detailed information about a dealer 402 registered to receive leads, and an interface for managing how the registered dealer 402 purchases leads.

The VWIS platform 410 is coupled or connected via a network to at least one remote electronic site or platform 412 that presents wholesale inventory to retail consumers 404, as described in detail below. The VWIS platform 410 also includes couplings or connections to dealers 402 via the network. The WVIRLGS includes a set of modules including, for example, a Virtual Wholesale Inventory (VWI) module 422, a Lead Acquisition Module (LAM) 414, and a Wholesale Automobile Market Module (WAMM) 416. The LAM 414 and WAMM 416 can be components of the VWIS platform 410, or can be hosted on one or more remote systems and coupled or connected to the VWIS platform 410.

The VWIS platform 410 presents or displays wholesale inventory to a retail consumer 404 using one or more different mechanisms. For example, inventory is presented using a service provider-owned and branded retail facing website. Inventory can also be presented using third party consumer-facing retail websites. Furthermore, inventory can be presented to a retail consumer using a dealer-owned website or kiosk. The retail consumer 404, upon establishing interest in a vehicle of the wholesale inventory, submits an expression of interest in the specific vehicle, thus creating a “lead”.

The lead submitted by the retail consumer 404 can be made available to automobile dealers 402 using one or more different mechanisms. For example, information of the lead is presented or made available to a dealer 402 via a website where the leads can be accessed, viewed and acquired. Also, information of the lead is presented or made available to a dealer 402 via an electronic mail (email) message or other messaging approach.

The dealer 402 may be granted rights to access the leads through one or more of the following processes. For example, the lead may be provided to the dealer for free by the consignor or wholesale marketplace. Moreover, the dealer 402 can subscribe to receive all leads satisfying pre-specified criteria (e.g., within a certain area, a vehicle type and/or a specified time period, etc.). Additionally, dealers 402 can acquire the leads via a “pay per lead” model.

The WVIRLGS interface for enabling the exposure of the wholesale vehicle inventory can include a data feed, web-service, flat text file, XML file, ETL file, or other data file exchange enabling the display of wholesale units to retail customers via presentation of detailed information for vehicles available in a wholesale marketplace (i.e., online wholesale auction, physical auction, including “buy-price only” marketplaces). The administrative component, in providing or generating this interface, generates a file including vehicles available in the wholesale market with a goal of facilitating a partnership between a retail automotive web-site and the provider of the service. The file includes, and the interface presents or makes use of, a data set, where each record comprises specific information about a vehicle, including, but not limited to, vehicle year, make, model, trim, mileage, VWIN (full or partial), colors, engine, drivetrain, transmission, damage information, consignor comments and pictures.

The administrative component generates the data set to specific partners. The data set can be generated or provided to partners via file transfer of the current data set. The data set can also be generated or provided to partners via request/response as in a web service where a partner requests the latest available inventory data. The administrative component, within the file, also comprises a mechanism for communicating where leads generated by the retail consumer are sent.

The interface for enabling the exposure of the wholesale vehicle inventory can include a retail-focused website (e.g., retail site) of wholesale inventory listings. The website of wholesale inventory listings is run by the provider of the service (or in partnership with another company) and allows a retail consumer to search among vehicles available in the wholesale marketplace and express interest in specific vehicles. The interface can be generated by the provider and can take the form of a stand-alone website or a “portlet” imbedded within a partners website, primarily geared towards the retail consumer.

The website of wholesale inventory listings comprises an interface for searching the set of specific vehicles accessible through the VWI module. The website of wholesale inventory listings can also comprise an interface for viewing the search results produced by the search interface. The website of wholesale inventory listings also can comprise an interface for viewing the details of a specific vehicle (i.e. a detail page), such as the year, make, model, trim, mileage, VWIN (full or partial), color, engine, drivetrain, transmission, damage information, consignor comments and pictures. The website of wholesale inventory listings can comprise an interface for the retail consumer to “express interest”, thereby generating a “lead”. This interface may require the inclusion of contact information for the retail consumer.

The interface for enabling the exposure of the wholesale vehicle inventory can include a “module” (i.e. portlet) that is or could be incorporated into a third party web-site (e.g., a specific dealer web-site, a third party retail classifieds web-site, etc). The module, which is referred to herein as the Virtual Wholesale Inventory module (VWI), is generated by the provider and is primarily geared towards the retail consumer. The VWI module allows a retail consumer to search among vehicles available in the wholesale marketplace and express interest in specific vehicles. The VWI module includes an interface for searching the set of vehicles accessible through the VWI module. The VWI module includes an interface for viewing the search results produced by the search interface. The VWI includes an interface for viewing the details of a specific vehicle (i.e. a detail page), such as the year, make, model, trim, mileage, VWIN (full or partial), color, engine, drivetrain, transmission, damage information, consignor comments, and pictures. The VWI includes an interface for the retail consumer to “Express interest”, thereby generating a “lead”; this interface may request a retail consumer to provide contact information. Each dealer web-site that presents the VWI can be independently owned and operated and have an independent URL.

The administrative component of an embodiment comprises an interface for capturing detailed information about a dealer registered to receive leads generated from the service, such as name, address, phone number and contacts.

The administrative component of an embodiment comprises an interface for managing whether the registered dealer is buying leads on a per transaction basis or a subscription basis. The subscription basis for buying leads comprises providing the dealer with exclusive rights to all leads generated by consumers within the defined geographic region.

The administrative component of an embodiment optionally comprises an interface for storing information related to payment for the acquired leads. The administrative component also optionally comprises an interface for managing a username and password for the dealer to access the LAM. Additionally, the administrative component optionally comprises an interface for managing which consignor's vehicles are visible through a data feed or on the retail-focused web-site. Furthermore, the administrative component optionally comprises an interface for establishing communication preferences, methods and contacts at the automobile dealer for leads generated from the presentation of the wholesale vehicles on the retail-focused web-site.

The LAM 414 is hosted by or coupled to the provider, primarily for use by a retail automobile dealer. The LAM 414 of an embodiment comprises at least one of the following interfaces, but the embodiment is not so limited: an interface for a dealer to enter a username and password to enter the module; an interface for searching the leads that have been generated; an interface for viewing a list of leads; an interface for viewing the details of a specific lead; an interface for acquiring the contact information of the retail consumer that generated the lead and a link to details for purchasing the specific vehicle from which the lead was generated; an interface for managing payment for the acquired leads; an interface for viewing and managing any leads previously acquired.

The WAMM 416, as described above, is hosted by or coupled to the provider and enables licensed dealers to purchase wholesale automotive inventory, and can be administered by the provider or a partner. The WAAM 416 of an embodiment comprises at least one of the following interfaces, but the embodiment is not so limited: an interface to register for access to the system; an interface for searching for a set of wholesale VWIN-specific inventory; an interface for viewing the search results produced by the search interface; an interface for viewing the details of a specific vehicle (e.g., a detail page), such as the year, make, model, trim, mileage, VWIN (full or partial), color, engine, drivetrain, transmission, damage information, consignor comments and pictures; an interface for bidding on or buying the available vehicle.

As described above, the TIP management system presents a dealer with an electronic interface that integrates inspection ordering, status tracking and receipt into an online system within an online wholesale marketplace to allow for a drastically simplified online wholesaling process. The wholesaling process can include and/or integrate with, for example, an electronic interface for purchasing the item or bidding on the item. The electronic interface for bidding on the item can include an interface of or link to a system comprising a bidding tool for electronic or online auctions. An example follows of an online auction system for use in bidding on the item, but the embodiment is not so limited. The item of the following auction system example is a vehicle, but the embodiment is not limited to a vehicle and can include any type, number, or combination of items. In the example system described below, the buyer corresponds to the dealer of the above-described embodiments of the TIP management system, and the seller corresponds to any third-party auctioning items in a wholesale market.

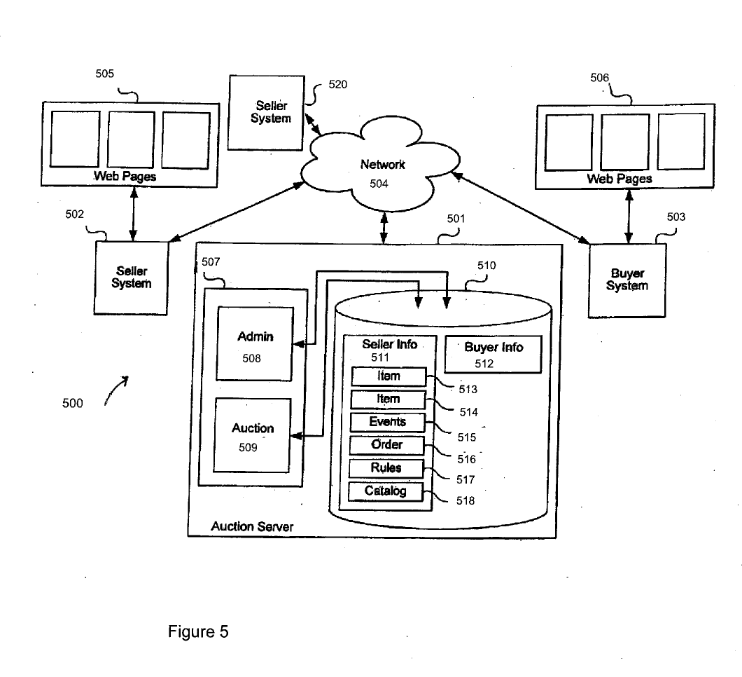

FIG. 5 is a block diagram of an online auction system 500, under an embodiment. Other tools and network configurations may be used according to other embodiments of the invention. The system shown includes an auction server 501, seller system 502, seller system 520, and buyer system 503. Also shown is network 504. Seller system 502 includes web pages 505, and buyer system 503 includes web pages 506. Auction server 501 includes software 507 and storage 510. Software 507 includes administrative software 508 and auction software 509, and storage includes seller information 511 and buyer information 512. Seller information 511 includes information such as vehicle information 513 and 514, and events information 515 which includes order 516, rules 517 and catalog 518. Auction server 501 is coupled to seller system 502 and buyer system 503 via network 504. Software 507 in auction server 501 operates with storage 510.

Seller system 502 includes functionality to manage inventory (such as vehicles), set up and modify bidding events, and manage bidding events. Such functionality may be included directly in seller system 502 or may be included in auction server 501 or in a combination of software or other logic located in seller system 502 and auction server 501.

Buyer system 503 includes functionality to view catalog items for bidding, to place bids and view an auction, and to select purchase, payment and delivery options for items purchased. This functionality may be included in functionality on buyer system 503, auction server 501 and/or combination of functionality located on auction server 501 and buyer system 503. The functionality may be implemented in software, hardware, or a combination of hardware and software according to various embodiments. Thus, according to various embodiments, the implementations described herein for software may also be implemented in various configurations of software and/or hardware, in distributed or other configurations in various machines and/or networks.

Auction server 501 includes software and storage to manage options and the users of the auctions. Administrative software 508 manages users and information related to users, such as seller information 511 and buyer information 512. Auction software 509 controls an auction including the progress of the auction as requested by seller system 502 and response to bids made by buyer system 503.

Seller system 502 includes web pages 505 that allow seller to enter and display information regarding auction events, inventory, and related administration. Buyer system 503 includes web pages 506 that allow a buyer to display information regarding bidding as well as enter information commands in order to participate in bidding in auctions.

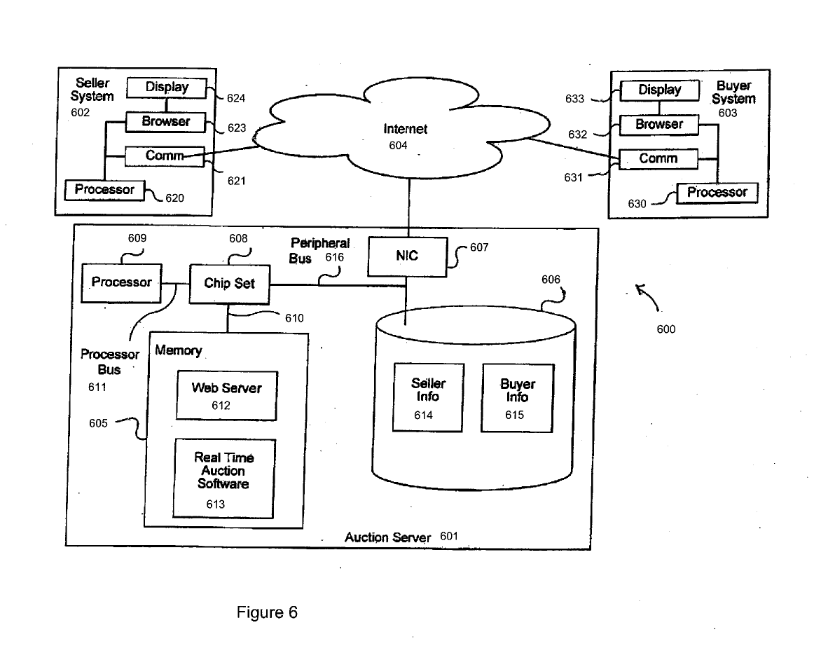

FIG. 6 is a more detailed block diagram of an online auction system, under an embodiment. Other tools and network configurations may be used according to other embodiments of the invention. In the system 600 shown are auction server 601, seller system 602, and buyer system 603. Auction server 601 is coupled to seller system 602 and buyer system 603 through Internet 604. Auction server 601 may include a processor 609 for processing instructions. Processor 609 is coupled to chip set 608 by a processor bus 611. Chip set 608 is coupled to memory 605 by a memory bus 610 and manages access to memory 605 by processor 609. Chip set 608 is also coupled to peripheral bus 616. Peripheral 616 bus can comprise, for example, PCI, PCI-X, PCI Express, or other peripheral bus. Auction server 601 also includes one or more network interface cards 607 coupled to peripheral bus 616 for providing network interfaces to network, such as Internet 604. Storage 606, such as a disk array or other non-voltage storage, is also coupled to peripheral bus 616.

According to various embodiments, memory 605 and/or storage 606 may include various forms of storage or computer-readable memories such as, but not limited to, volatile memory (random access memory (“RAM”), non-volatile memory (read-only memory (“ROM”)), EEPROM, disk, and/or other storage devices that may include one or more of magnetic, optical storage, or other media. The memory and/or storage on the auction server may be configured as a RAID (Redundant Array of Independent Disks) configuration to provide high reliability access to software and data.

Software may be loaded into memory 605 to help provide auction/bidding function for auction server 601. For example, web server 612 and real-time auction software 613 may be loaded into memory 605 and run by processor 609. Web server 612 provides web pages for the users to interact with in order to be provided with auctions/bidding functions. For example, web server 612 may serve up web pages to seller system 602 and buyer system 603 in order to allow seller system 602 to manage inventory events and bidding and to allow buyer system 603 to view events and auction items to make bids and to participate in auctions. Storage 606 includes information about respective users, such as seller information 614 and buyer information 615. This information is used in order to manage the inventory of items for sale, configuration of bidding events, and the processing of real-time bidding. According to various embodiments of the invention, auction system 600 may include one or a plurality of auction servers 601 in various configurations and architectures to provide auctions and bidding functionality.

Seller system 602 and/or buyer system 603 may comprise computer systems coupled to a network such as Internet 604 according to an embodiment. As shown, seller system 602 includes processor 620 and software components such as a browser 623 and communications software 621. Also included is a display 624 that allows a user to see information regarding auctions and to perform related administration. Buyer system 603 also includes a processor 630, communication software 631, browser 632, and display 633. Various browser software or other software or functionality to provide user interaction may be used in buyer and seller systems. For example, browsers may include, but are not limited to, Internet Explorer, Netscape browser, Firefox browser, Safari browser or other browser. Alternatively, other user interface software not including a browser may be used.

Software such as web server 612 and real-time auction software 613 may be stored in storage 606 or other storage and may be loaded into memory 605 for manipulation by processor 609 according to an embodiment of the invention. Portions of data such as seller information 614 and buyer information 615 may be loaded into data structures in memory 605 or other storage for manipulation by processor 609 in accordance with software such as web server 612 and real-time auction software 613. Web server 612 includes an operating system for managing system resources, as well as applications software running on top of the operating systems for implementing an HTML server or other server. Information stored in storage 606 may be stored in various forms of database arrangements and may contain cross references or links to one another to allow information to be queried and retrieved. In an example embodiment, the information is stored in databases, such as relational databases, and may be queried using structured query language (SQL) or other mechanism.

The system may include a secure connection or connections. For example, in an embodiment of the invention, the entire bidding operation of the system operates on a secure connection or connections. Various different technologies may be used to provide a secure connection, such as encryption with, for example, public key and private key encryption. The system may be set up over a virtual private network (VPN).

In an example embodiment, a seller operates seller system 602 through browser 623, communications software 621, and display 624 to set up seller inventory and seller events in seller information storage 614. The seller-user also manages the events and bidding through seller system 602, which communicates via Internet 604 with web server 612.

Buyer system 603 interacts with a buyer user, allowing the buyer user to view items and events including the items for auction. The interaction is provided to the buyer user through display 633, browser 632, and communications software 631, which are controlled by processor 630. Buyer system in turn communicates with auction server 601 via Internet 604. Web server 612 in turn provides buyer system 603 with graphical interface pages which may be displayed on display 633.

Embodiments described herein include a system comprising a platform including a plurality of items and data of the plurality of items. The plurality of items is in a wholesale market and is available for purchase only by a dealer in the wholesale market. The system of an embodiment includes a wholesale automobile market module (WAMM) coupled to the platform. The WAMM comprises a wholesale inventory of the plurality of items available for purchase in the wholesale market. The system of an embodiment includes an inspection management system (IMS) coupled to the platform. The IMS comprises a plurality of modules with interfaces that enable the dealer to select an inspector of a plurality of inspectors to inspect the at least one item, receive inspection results, and automatically distribute the inspection results in the wholesale marketplace.

Embodiments described herein include a system comprising: a platform comprising a plurality of items and data of the plurality of items, wherein the plurality of items is in a wholesale market and is available for purchase only by a dealer in the wholesale market; a wholesale automobile market module (WAMM) coupled to the platform, the WAMM comprising a wholesale inventory of the plurality of items available for purchase in the wholesale market; and an inspection management system (IMS) coupled to the platform, the IMS comprising a plurality of modules with interfaces that enable the dealer to select an inspector of a plurality of inspectors to inspect the at least one item, receive inspection results, and automatically distribute the inspection results in the wholesale marketplace.

The WAMM of an embodiment comprises a search interface for searching the wholesale inventory, and a viewing interface for viewing results of the searching and the data of the wholesale inventory.

The WAMM of an embodiment comprises an interface for use only by the dealer for at least one of purchasing and bidding on an item of the wholesale inventory.

The automatic distribution of the inspection results of an embodiment comprises transferring the inspection results to the dealer via the WAMM.

The automatic distribution of the inspection results of an embodiment comprises transferring the inspection results to the WAMM.

The automatic distribution of the inspection results of an embodiment comprises generating a notification to the dealer regarding availability of the inspection results via the WAMM.

The WAMM of an embodiment includes a WAM interface for controlling setting of wholesale prices of the plurality of items.

The WAMM of an embodiment includes a WAM interface for controlling selling of the plurality of items via an electronic site.

The WAMM of an embodiment includes a WAM interface for controlling selling of the plurality of items via an electronic auction site.

The plurality of modules of an embodiment comprise an inspection scheduling module (ISM), wherein the ISM comprises a selection interface for the selecting of the inspector to perform the inspection and selecting a day and time for the inspection.

The plurality of modules of an embodiment comprise an inspection ordering module (IOM), wherein the IOM includes an IOM interface having controls for accessing the IOM.

The IOM interface of an embodiment comprises controls for searching a set of items corresponding to the dealer, wherein the plurality of items includes the set of items.

The IOM interface of an embodiment comprises controls for selecting at least one item from the set of items and ordering an inspection for the at least one item.

The selecting of an embodiment comprises entering an identification number for the at least one item.

The IOM interface of an embodiment comprises controls for selecting a location of the at least one item selected for inspection.

The IOM of an embodiment automatically generates and transfers to a selected inspector via the platform an electronic order for the inspection of the at least one item.

The IOM of an embodiment interface comprises controls for accessing historical performance data of a selected inspector.

The plurality of modules of an embodiment comprise an inspection status tracking module (ISTM), wherein the ISTM includes an IST interface having controls for accessing the ISTM.

The IST interface of an embodiment comprises controls for accessing a status of the inspection.

The IST interface of an embodiment comprises controls for accessing inspector notes corresponding to the status.

The IST interface of an embodiment comprises controls for searching and viewing a set of items corresponding to the dealer and for which an inspection has been ordered.

The IST interface of an embodiment comprises controls for accessing and viewing data of each item of the set of items.

The IST interface of an embodiment comprises controls for cancelling the inspection.

The IST interface of an embodiment comprises controls for managing notifications relating to the inspection.

The ISTM of an embodiment generates the notifications and electronically transmits the notifications.

The notifications of an embodiment comprise at least one of electronic mail messages, short message service messages.

The notifications of an embodiment comprise notification of ordering the inspection.

The notifications of an embodiment comprise notification of cancellation of the inspection.

The notifications of an embodiment comprise notification of completion of the inspection.

The plurality of modules of an embodiment comprises a data exchange module (DEM), wherein the DEM includes a DEM interface.

The DEM interface of an embodiment comprises an interface for communicating inspection orders.

The DEM interface of an embodiment comprises an interface for communicating inspection cancellations.

The DEM interface of an embodiment comprises an interface for communicating inspection status.

The DEM interface of an embodiment comprises an interface for communicating completed inspections.

The DEM interface of an embodiment comprises an interface for communicating billing information of the inspection.

The plurality of modules of an embodiment comprises an inspection distribution module (IDM) that controls the automatically distributing of the inspection results, wherein the IDM includes a IDM interface.

The IDM interface of an embodiment comprises controls for the automatically distributing the inspection results.

The IDM interface of an embodiment comprises controls for at least one of selecting at least one recipient of the inspection results.

The IDM interface of an embodiment comprises controls for selecting at least one element of the inspection results for the distributing.

The IDM interface of an embodiment comprises controls for limiting elements of the inspection results prior to the distributing.

The IDM interface of an embodiment comprises controls for paying for the automatically distributing of the inspection results.

The plurality of modules of an embodiment comprises an administration module that includes an administration interface.

The administration interface of an embodiment comprises controls for at least one of loading and inputting data of the plurality of inspectors.

The administration interface of an embodiment comprises controls for capturing data of the dealer, wherein the database comprises the data of a plurality of dealers that comprise the dealer.

The administration interface of an embodiment comprises a billing interface comprising controls for managing billing of the dealer for the inspection.

The administration interface of an embodiment comprises controls for capturing data of pricing structures of the plurality of inspectors.

The administration interface of an embodiment comprises controls for capturing data of geographic coverage of the plurality of inspectors.

The system of an embodiment comprises an inventory management module (IMM), wherein the IMM comprises an inventory management interface (IMI).

The IMI of an embodiment comprises controls for providing the dealer with electronic access to the plurality of items.

The IMI of an embodiment comprises controls for providing the dealer with a search interface for searching the plurality of items, and a viewing interface for viewing results of the searching and the data of the plurality of items.

The IMI of an embodiment comprises controls for use only by the dealer for at least one of purchasing and bidding on the item in the plurality of items.

The IMI of an embodiment comprises controls for transferring the data of the plurality of items at least one of to and from the database.

The IMI of an embodiment comprises controls for integrating the data of the plurality of items into the database.

Embodiments described herein include a system comprising a platform including a processor and a database that includes a plurality of items and data of the plurality of items. The plurality of items is in a wholesale market and is available for purchase only by a dealer in the wholesale market. The database includes data of a plurality of inspectors that are third-party inspectors. The system of an embodiment includes a wholesale automobile market module (WAMM) coupled to the platform. The WAMM comprises a wholesale inventory of the plurality of items available for purchase in the wholesale market. The system of an embodiment includes an inspection management system (IMS) coupled to the platform. The IMS comprises a plurality of modules with interfaces that enable the dealer to select from the plurality of inspectors an inspector to inspect the at least one item, receive inspection results, and automatically distribute the inspection results in the wholesale marketplace.

Embodiments described herein include a system comprising: a platform comprising a processor and a database that includes a plurality of items and data of the plurality of items, wherein the plurality of items is in a wholesale market and is available for purchase only by a dealer in the wholesale market, wherein the database includes data of a plurality of inspectors that are third-party inspectors; a wholesale automobile market module (WAMM) coupled to the platform, the WAMM comprising a wholesale inventory of the plurality of items available for purchase in the wholesale market; and an inspection management system (IMS) coupled to the platform, the IMS comprising a plurality of modules with interfaces that enable the dealer to select from the plurality of inspectors an inspector to inspect the at least one item, receive inspection results, and automatically distribute the inspection results in the wholesale marketplace.

Embodiments described herein include a method comprising presenting via a platform a plurality of items and data of the plurality of items to a dealer. The plurality of items is in a wholesale market and is available for purchase only by the dealer in the wholesale market. The method of an embodiment comprises presenting via a wholesale automobile market module (WAMM) coupled to the platform a wholesale inventory comprising the plurality of items. The method of an embodiment comprises presenting via an inspection management system (IMS) coupled to the platform a plurality of interfaces that enable the dealer to select from a plurality of inspectors an inspector to inspect the at least one item, receive inspection results, and automatically distribute via the platform the inspection results in the wholesale marketplace.

Embodiments described herein include a method comprising: presenting via a platform a plurality of items and data of the plurality of items to a dealer, wherein the plurality of items is in a wholesale market and is available for purchase only by the dealer in the wholesale market; presenting via a wholesale automobile market module (WAMM) coupled to the platform a wholesale inventory comprising the plurality of items; and presenting via an inspection management system (IMS) coupled to the platform a plurality of interfaces that enable the dealer to select from a plurality of inspectors an inspector to inspect the at least one item, receive inspection results, and automatically distribute via the platform the inspection results in the wholesale marketplace.

The method of an embodiment comprises presenting via the WAMM a search interface for searching the wholesale inventory, and a viewing interface for viewing results of the searching and the data of the wholesale inventory.

The method of an embodiment comprises presenting via the WAMM an interface for use only by the dealer for at least one of purchasing and bidding on an item of the wholesale inventory.

Automatically distributing the inspection results of an embodiment comprises transferring the inspection results to the dealer via the WAMM.

Automatically distributing the inspection results of an embodiment comprises transferring the inspection results to the WAMM.

Automatically distributing the inspection results of an embodiment comprises generating a notification to the dealer regarding availability of the inspection results via the WAMM.

The method of an embodiment comprises presenting via the WAMM a WAM interface for controlling setting of wholesale prices of the plurality of items.

The method of an embodiment comprises presenting via the WAMM a WAM interface for controlling selling of the plurality of items via an electronic site.

The method of an embodiment comprises presenting via the WAMM a WAM interface for controlling selling of the plurality of items via an electronic auction site.

The method of an embodiment comprises presenting via an inspection scheduling module (ISM) coupled to the platform a selection interface for the selecting of the inspector to perform the inspection and selecting a day and time for the inspection.

The method of an embodiment comprises presenting via an inspection ordering module (IOM) coupled to the platform an IOM interface having controls for accessing the IOM.

The method of an embodiment comprises presenting via the IOM interface controls for searching a set of items corresponding to the dealer, wherein the plurality of items includes the set of items.

The method of an embodiment comprises presenting via the IOM interface controls for selecting at least one item from the set of items and ordering an inspection for the at least one item.

The selecting of an embodiment comprises entering an identification number for the at least one item.

The method of an embodiment comprises presenting via the IOM interface controls for selecting a location of the at least one item selected for inspection.

The method of an embodiment comprises the IOM automatically generating and transferring to a selected inspector via the platform an electronic order for the inspection of the at least one item.

The method of an embodiment comprises presenting via the IOM interface controls for accessing historical performance data of a selected inspector.

The method of an embodiment comprises presenting via an inspection status tracking module (ISTM) coupled to the platform an IST interface having controls for accessing the ISTM.

The method of an embodiment comprises presenting via the IST interface controls for accessing a status of the inspection.

The method of an embodiment comprises presenting via the IST interface controls for accessing inspector notes corresponding to the status.

The method of an embodiment comprises presenting via the IST interface controls for searching and viewing a set of items corresponding to the dealer and for which an inspection has been ordered.

The method of an embodiment comprises presenting via the IST interface controls for accessing and viewing data of each item of the set of items.

The method of an embodiment comprises presenting via the IST interface controls for cancelling the inspection.

The method of an embodiment comprises presenting via the IST interface controls for managing notifications relating to the inspection.

The method of an embodiment comprises the ISTM generating the notifications and electronically transmitting the notifications.

The notifications of an embodiment comprise at least one of electronic mail messages, short message service messages.

The notifications of an embodiment comprise notification of ordering the inspection.

The notifications of an embodiment comprise notification of cancellation of the inspection.

The notifications of an embodiment comprise notification of completion of the inspection.

The method of an embodiment comprises presenting via a data exchange module (DEM) coupled to the platform a DEM interface.

The method of an embodiment comprises presenting via the DEM interface an interface for communicating inspection orders.

The method of an embodiment comprises presenting via the DEM interface an interface for communicating inspection cancellations.

The method of an embodiment comprises presenting via the DEM interface an interface for communicating inspection status.

The method of an embodiment comprises presenting via the DEM interface an interface for communicating completed inspections.

The method of an embodiment comprises presenting via the DEM interface an interface for communicating billing information of the inspection.

The method of an embodiment comprises presenting via an inspection distribution module (IDM) coupled to the platform an IDM interface, wherein the IDM controls the automatic distributing of the inspection results.

The method of an embodiment comprises presenting via the IDM interface controls for the automatically distributing the inspection results.

The method of an embodiment comprises presenting via the IDM interface controls for at least one of selecting at least one recipient of the inspection results.

The method of an embodiment comprises presenting via the IDM interface controls for selecting at least one element of the inspection results for the distributing.

The method of an embodiment comprises presenting via the IDM interface controls for limiting elements of the inspection results prior to the distributing.

The method of an embodiment comprises presenting via the IDM interface controls for paying for the automatically distributing of the inspection results.

The method of an embodiment comprises presenting via an administration module coupled to the platform an administration interface.

The method of an embodiment comprises presenting via the administration interface controls for at least one of loading and inputting data of the plurality of inspectors.

The method of an embodiment comprises presenting via the administration interface controls for capturing data of the dealer, wherein the database comprises the data of a plurality of dealers that comprise the dealer.

The method of an embodiment comprises presenting via the administration interface a billing interface comprising controls for managing billing of the dealer for the inspection.

The method of an embodiment comprises presenting via the administration interface controls for capturing data of pricing structures of the plurality of inspectors.

The method of an embodiment comprises presenting via the administration interface controls for capturing data of geographic coverage of the plurality of inspectors.

The method of an embodiment comprises presenting via an inventory management module (IMM) coupled to the platform an inventory management interface (IMI).

The method of an embodiment comprises presenting via the IMI controls for providing the dealer with electronic access to the plurality of items.

The method of an embodiment comprises presenting via the IMI controls for providing the dealer with a search interface for searching the plurality of items, and a viewing interface for viewing results of the searching and the data of the plurality of items.

The method of an embodiment comprises presenting via the IMI controls for use only by the dealer for at least one of purchasing and bidding on the item in the plurality of items.

The method of an embodiment comprises presenting via the IMI controls for transferring the data of the plurality of items at least one of to and from the database.

The method of an embodiment comprises presenting via the IMI controls for integrating the data of the plurality of items into the database.

Networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The TPI management system can be a component of a single system, multiple systems, and/or geographically separate systems. The TPI management system can also be a subcomponent or subsystem of a single system, multiple systems, and/or geographically separate systems. The TPI management system can be coupled to one or more other components (not shown) of a host system or a system coupled to the host system.

One or more components of the TPI management system and/or a corresponding system or application to which the TPI management system is coupled or connected include and/or run under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that includes the TPI management system can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the TPI management system and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the TPI management system and corresponding systems and methods include: microcontrollers with memory (such as electronically erasable programmable read only memory (EEPROM)), embedded microprocessors, firmware, software, etc. Furthermore, aspects of the TPI management system and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the TPI management system and corresponding systems and methods is not intended to be exhaustive or to limit the systems and methods to the precise forms disclosed. While specific embodiments of, and examples for, the TPI management system and corresponding systems and methods are described herein for illustrative purposes, various equivalent modifications are possible within the scope of the systems and methods, as those skilled in the relevant art will recognize. The teachings of the TPI management system and corresponding systems and methods provided herein can be applied to other systems and methods, not only for the systems and methods described above.

The elements and acts of the various embodiments described above can be combined to provide further embodiments. These and other changes can be made to the TPI management system and corresponding systems and methods in light of the above detailed description.

In general, in the following claims, the terms used should not be construed to limit the TPI management system and corresponding systems and methods to the specific embodiments disclosed in the specification and the claims, but should be construed to include all systems that operate under the claims. Accordingly, the TPI management system and corresponding systems and methods is not limited by the disclosure, but instead the scope is to be determined entirely by the claims.

While certain aspects of the TPI management system and corresponding systems and methods are presented below in certain claim forms, the inventors contemplate the various aspects of the TPI management system and corresponding systems and methods in any number of claim forms. Accordingly, the inventors reserve the right to add additional claims after filing the application to pursue such additional claim forms for other aspects of the TPI management system and corresponding systems and methods.

What is claimed is:

1. A system comprising:
a platform comprising a plurality of items and data of the plurality of items, wherein the plurality of items is in a wholesale market and is available for purchase only by a dealer in the wholesale market;
a wholesale automobile market module (WAMM) coupled to the platform, the WAMM comprising a wholesale inventory of the plurality of items available for purchase in the wholesale market; and
an inspection management system (IMS) coupled to the platform, the IMS comprising a plurality of modules with interfaces that enable the dealer to select an inspector of a plurality of inspectors to inspect the at least one item, receive inspection results, and automatically distribute the inspection results in the wholesale marketplace.

2. The system of claim 1, wherein the WAMM comprises a search interface for searching the wholesale inventory, and a viewing interface for viewing results of the searching and the data of the wholesale inventory.

3. The system of claim 1, wherein the WAMM comprises an interface for use only by the dealer for at least one of purchasing and bidding on an item of the wholesale inventory.

4. The system of claim 1, wherein the automatic distribution of the inspection results comprises transferring the inspection results to the dealer via the WAMM.

5. The system of claim 1, wherein the automatic distribution of the inspection results comprises transferring the inspection results to the WAMM.

6. The system of claim 5, wherein the automatic distribution of the inspection results comprises generating a notification to the dealer regarding availability of the inspection results via the WAMM.

7. The system of claim 1, wherein the WAMM includes a WAM interface for controlling setting of wholesale prices of the plurality of items.

8. The system of claim 1, wherein the WAMM includes a WAM interface for controlling selling of the plurality of items via an electronic site.

9. The system of claim 1, wherein the WAMM includes a WAM interface for controlling selling of the plurality of items via an electronic auction site.

10. The system of claim 1, wherein the plurality of modules comprise an inspection scheduling module (ISM), wherein the ISM comprises a selection interface for the selecting of the inspector to perform the inspection and selecting a day and time for the inspection.

11. The system of claim 1, wherein the plurality of modules comprise an inspection ordering module (IOM), wherein the IOM includes an IOM interface having controls for accessing the IOM.

12. The system of claim 11, wherein the IOM interface comprises controls for searching a set of items corresponding to the dealer, wherein the plurality of items includes the set of items.

13. The system of claim 12, wherein the IOM interface comprises controls for selecting at least one item from the set of items and ordering an inspection for the at least one item.

14. The system of claim 13, wherein the selecting comprises entering an identification number for the at least one item.

15. The system of claim 13, wherein the IOM interface comprises controls for selecting a location of the at least one item selected for inspection.

16. The system of claim 15, wherein the IOM automatically generates and transfers to a selected inspector via the platform an electronic order for the inspection of the at least one item.

17. The system of claim 11, wherein the IOM interface comprises controls for accessing historical performance data of a selected inspector.

18. The system of claim 1, wherein the plurality of modules comprise an inspection status tracking module (ISTM), wherein the ISTM includes an IST interface having controls for accessing the ISTM.

19. The system of claim 18, wherein the IST interface comprises controls for accessing a status of the inspection.

20. The system of claim 19, wherein the IST interface comprises controls for accessing inspector notes corresponding to the status.

21. The system of claim 18, wherein the IST interface comprises controls for searching and viewing a set of items corresponding to the dealer and for which an inspection has been ordered.

22. The system of claim 21, wherein the IST interface comprises controls for accessing and viewing data of each item of the set of items.

23. The system of claim 18, wherein the IST interface comprises controls for cancelling the inspection.

24. The system of claim 18, wherein the IST interface comprises controls for managing notifications relating to the inspection.

25. The system of claim 24, wherein the ISTM generates the notifications and electronically transmits the notifications.

26. The system of claim 25, wherein the notifications comprise at least one of electronic mail messages, short message service messages.

27. The system of claim 25, wherein the notifications comprise notification of ordering the inspection.

28. The system of claim 25, wherein the notifications comprise notification of cancellation of the inspection.

29. The system of claim 25, wherein the notifications comprise notification of completion of the inspection.

30. The system of claim 1, wherein the plurality of modules comprise a data exchange module (DEM), wherein the DEM includes a DEM interface.

31. The system of claim 30, wherein the DEM interface comprises an interface for communicating inspection orders.

32. The system of claim 30, wherein the DEM interface comprises an interface for communicating inspection cancellations.

33. The system of claim 30, wherein the DEM interface comprises an interface for communicating inspection status.

34. The system of claim 30, wherein the DEM interface comprises an interface for communicating completed inspections.

35. The system of claim 30, wherein the DEM interface comprises an interface for communicating billing information of the inspection.

36. The system of claim 1, wherein the plurality of modules comprise an inspection distribution module (IDM) that controls the automatically distributing of the inspection results, wherein the IDM includes a IDM interface.

37. The system of claim 36, wherein the IDM interface comprises controls for the automatically distributing the inspection results.

38. The system of claim 36, wherein the IDM interface comprises controls for at least one of selecting at least one recipient of the inspection results.

39. The system of claim 36, wherein the IDM interface comprises controls for selecting at least one element of the inspection results for the distributing.

40. The system of claim 36, wherein the IDM interface comprises controls for limiting elements of the inspection results prior to the distributing.

41. The system of claim 36, wherein the IDM interface comprises controls for paying for the automatically distributing of the inspection results.

42. The system of claim 1, wherein the plurality of modules comprise an administration module that includes an administration interface.

43. The system of claim 42, wherein the administration interface comprises controls for at least one of loading and inputting data of the plurality of inspectors.

44. The system of claim 42, wherein the administration interface comprises controls for capturing data of the dealer, wherein the database comprises the data of a plurality of dealers that comprise the dealer.

45. The system of claim 42, wherein the administration interface comprises a billing interface comprising controls for managing billing of the dealer for the inspection.

46. The system of claim 42, wherein the administration interface comprises controls for capturing data of pricing structures of the plurality of inspectors.

47. The system of claim 42, wherein the administration interface comprises controls for capturing data of geographic coverage of the plurality of inspectors.

48. The system of claim 1, comprising an inventory management module (IMM), wherein the IMM comprises an inventory management interface (IMI).

49. The system of claim 48, wherein the IMI comprises controls for providing the dealer with electronic access to the plurality of items.

50. The system of claim 48, wherein the IMI comprises controls for providing the dealer with a search interface for searching the plurality of items, and a viewing interface for viewing results of the searching and the data of the plurality of items.

51. The system of claim 48, wherein the IMI comprises controls for use only by the dealer for at least one of purchasing and bidding on the item in the plurality of items.

52. The system of claim 48, wherein the IMI comprises controls for transferring the data of the plurality of items at least one of to and from the database.

53. The system of claim 48, wherein the IMI comprises controls for integrating the data of the plurality of items into the database.

54. A system comprising:
a platform comprising a processor and a database that includes a plurality of items and data of the plurality of items, wherein the plurality of items is in a wholesale market and is available for purchase only by a dealer in the wholesale market, wherein the database includes data of a plurality of inspectors that are third-party inspectors;
a wholesale automobile market module (WAMM) coupled to the platform, the WAMM comprising a wholesale inventory of the plurality of items available for purchase in the wholesale market; and
an inspection management system (IMS) coupled to the platform, the IMS comprising a plurality of modules with interfaces that enable the dealer to select from the plurality of inspectors an inspector to inspect the at least one item, receive inspection results, and automatically distribute the inspection results in the wholesale marketplace.

55. A method comprising:
presenting via a platform a plurality of items and data of the plurality of items to a dealer, wherein the plurality of items is in a wholesale market and is available for purchase only by the dealer in the wholesale market;
presenting via a wholesale automobile market module (WAMM) coupled to the platform a wholesale inventory comprising the plurality of items; and
presenting via an inspection management system (IMS) coupled to the platform a plurality of interfaces that enable the dealer to select from a plurality of inspectors an inspector to inspect the at least one item, receive inspection results, and automatically distribute via the platform the inspection results in the wholesale marketplace.

56. The method of claim 55, comprising presenting via the WAMM a search interface for searching the wholesale inventory, and a viewing interface for viewing results of the searching and the data of the wholesale inventory.

57. The method of claim 55, comprising presenting via the WAMM an interface for use only by the dealer for at least one of purchasing and bidding on an item of the wholesale inventory.

58. The method of claim 55, wherein automatically distributing the inspection results comprises transferring the inspection results to the dealer via the WAMM.

59. The method of claim 55, wherein automatically distributing the inspection results comprises transferring the inspection results to the WAMM.

60. The method of claim 59, wherein automatically distributing the inspection results comprises generating a notification to the dealer regarding availability of the inspection results via the WAMM.

61. The method of claim 55, comprising presenting via the WAMM a WAM interface for controlling setting of wholesale prices of the plurality of items.

62. The method of claim 55, comprising presenting via the WAMM a WAM interface for controlling selling of the plurality of items via an electronic site.

63. The method of claim 55, comprising presenting via the WAMM a WAM interface for controlling selling of the plurality of items via an electronic auction site.

64. The method of claim 55, comprising presenting via an inspection scheduling module (ISM) coupled to the platform a selection interface for the selecting of the inspector to perform the inspection and selecting a day and time for the inspection.

65. The method of claim 55, comprising presenting via an inspection ordering module (IOM) coupled to the platform an IOM interface having controls for accessing the IOM.

66. The method of claim 65, comprising presenting via the IOM interface controls for searching a set of items corresponding to the dealer, wherein the plurality of items includes the set of items.

67. The method of claim 66, comprising presenting via the IOM interface controls for selecting at least one item from the set of items and ordering an inspection for the at least one item.

68. The method of claim 67, wherein the selecting comprises entering an identification number for the at least one item.

69. The method of claim 67, comprising presenting via the IOM interface controls for selecting a location of the at least one item selected for inspection.

70. The method of claim 69, comprising the IOM automatically generating and transferring to a selected inspector via the platform an electronic order for the inspection of the at least one item.

71. The method of claim 65, comprising presenting via the IOM interface controls for accessing historical performance data of a selected inspector.

72. The method of claim 55, comprising presenting via an inspection status tracking module (ISTM) coupled to the platform an IST interface having controls for accessing the ISTM.

73. The method of claim 72, comprising presenting via the IST interface controls for accessing a status of the inspection.

74. The method of claim 73, comprising presenting via the IST interface controls for accessing inspector notes corresponding to the status.

75. The method of claim 72, comprising presenting via the IST interface controls for searching and viewing a set of items corresponding to the dealer and for which an inspection has been ordered.

76. The method of claim 75, comprising presenting via the IST interface controls for accessing and viewing data of each item of the set of items.

77. The method of claim 72, comprising presenting via the IST interface controls for cancelling the inspection.

78. The method of claim 72, comprising presenting via the IST interface controls for managing notifications relating to the inspection.

79. The method of claim 78, comprising the ISTM generating the notifications and electronically transmitting the notifications.

80. The method of claim 79, wherein the notifications comprise at least one of electronic mail messages, short message service messages.

81. The method of claim 79, wherein the notifications comprise notification of ordering the inspection.

82. The method of claim 79, wherein the notifications comprise notification of cancellation of the inspection.

83. The method of claim 79, wherein the notifications comprise notification of completion of the inspection.

84. The method of claim 55, comprising presenting via a data exchange module (DEM) coupled to the platform a DEM interface.

85. The method of claim 84, comprising presenting via the DEM interface an interface for communicating inspection orders.

86. The method of claim 84, comprising presenting via the DEM interface an interface for communicating inspection cancellations.

87. The method of claim 84, comprising presenting via the DEM interface an interface for communicating inspection status.

88. The method of claim 84, comprising presenting via the DEM interface an interface for communicating completed inspections.

89. The method of claim 84, comprising presenting via the DEM interface an interface for communicating billing information of the inspection.

90. The method of claim 55, comprising presenting via an inspection distribution module (IDM) coupled to the platform an IDM interface, wherein the IDM controls the automatic distributing of the inspection results.

91. The method of claim 90, comprising presenting via the IDM interface controls for the automatically distributing the inspection results.

92. The method of claim 90, comprising presenting via the IDM interface controls for at least one of selecting at least one recipient of the inspection results.

93. The method of claim 90, comprising presenting via the IDM interface controls for selecting at least one element of the inspection results for the distributing.

94. The method of claim 90, comprising presenting via the IDM interface controls for limiting elements of the inspection results prior to the distributing.

95. The method of claim 90, comprising presenting via the IDM interface controls for paying for the automatically distributing of the inspection results.

96. The method of claim 55, comprising presenting via an administration module coupled to the platform an administration interface.

97. The method of claim 96, comprising presenting via the administration interface controls for at least one of loading and inputting data of the plurality of inspectors.

98. The method of claim 96, comprising presenting via the administration interface controls for capturing data of the dealer, wherein the database comprises the data of a plurality of dealers that comprise the dealer.

99. The method of claim 96, comprising presenting via the administration interface a billing interface comprising controls for managing billing of the dealer for the inspection.

100. The method of claim 96, comprising presenting via the administration interface controls for capturing data of pricing structures of the plurality of inspectors.

101. The method of claim 96, comprising presenting via the administration interface controls for capturing data of geographic coverage of the plurality of inspectors.

102. The method of claim 55, comprising presenting via an inventory management module (IMM) coupled to the platform an inventory management interface (IMI).

103. The method of claim 102, comprising presenting via the IMI controls for providing the dealer with electronic access to the plurality of items.

104. The method of claim 102, comprising presenting via the IMI controls for providing the dealer with a search interface for searching the plurality of items, and a viewing interface for viewing results of the searching and the data of the plurality of items.

105. The method of claim 102, comprising presenting via the IMI controls for use only by the dealer for at least one of purchasing and bidding on the item in the plurality of items.

106. The method of claim 102, comprising presenting via the IMI controls for transferring the data of the plurality of items at least one of to and from the database.

107. The method of claim 102, comprising presenting via the IMI controls for integrating the data of the plurality of items into the database.
